(19) United States
(12) Patent Application Publication
(10) Pub. No.: US 2026/0365459 A1
(43) Pub. Date: Nov. 19, 2026

(54) DEVICE AND METHOD FOR CONVEYING CLOSURE LIDS

(71) Applicant: SAETA GMBH & CO. KG, Ludwigslust (DE)

(72) Inventor: Florian HAAR, Rellingen (DE)

(21) Appl. No.: 19/145,905

(22) PCT Filed: Dec. 29, 2023
(86) PCT No.: PCT/EP2023/087978

§ 371 Date: Jul. 4, 2025

(30) Foreign Application Priority Data
Jan. 6, 2023 (DE) 10 2023 100 250.3

(51) Int. Cl. B65G 59/10; B65G 59/06

(52) U.S. Cl. CPC B65G 59/108; B65G 59/066

(57) ABSTRACT

The invention relates to a device for conveying closure lids, in particular for cans, comprising a stacking device for receiving a stack of closure lids, additionally comprising a transfer apparatus for transferring the lowermost closure lids in the stacking device in each case to an apparatus for further processing, wherein the transfer apparatus has at least one receiving area for a closure lid, and comprising a conveyor worm apparatus with at least one conveyor worm and a worm drive, by means of which the at least one conveyor worm can be driven in a drive direction so that the at least one conveyor worm supplies the closure lids individually from the stacking device to the at least one receiving area of the transfer apparatus, wherein the at least one conveyor worm can be driven and stopped by means of the worm drive independently of the transfer apparatus, and wherein a control apparatus is provided which is designed to actuate the worm drive after the at least one conveyor worm has been stopped in order to drive the at least one conveyor worm counter to the drive direction before being started up again. The invention also relates to a corresponding method.

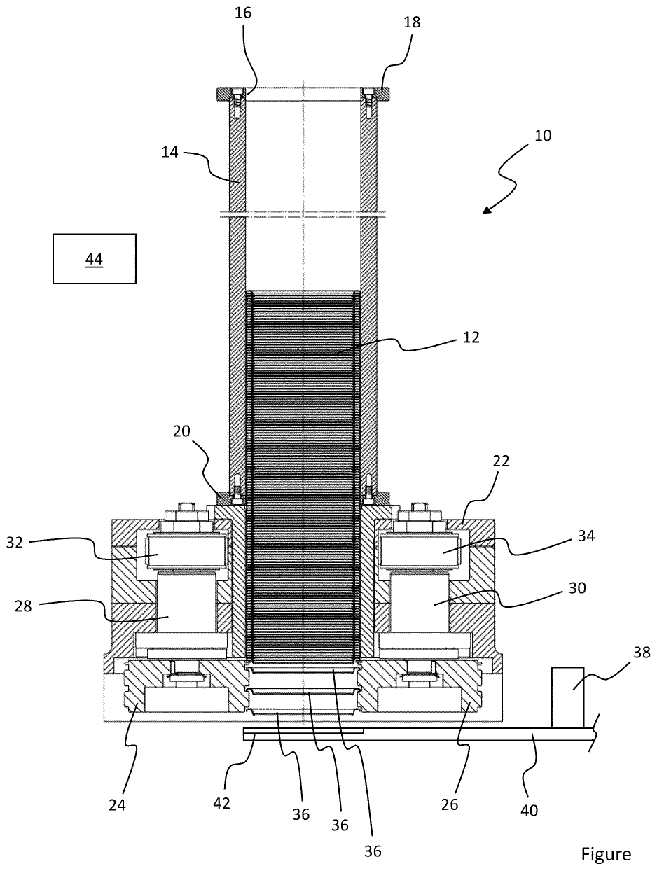

The invention relates to a device for conveying closure lids, in particular for cans, comprising a stacking device for receiving a stack of closure lids, additionally comprising a transfer apparatus for transferring the lowermost closure lids in the stacking device in each case to an apparatus for further processing, wherein the transfer apparatus has at least one receiving area for a closure lid, and comprising a conveyor worm apparatus with at least one conveyor worm and a worm drive, by means of which the at least one conveyor worm can be driven in a drive direction so that the at least one conveyor worm supplies the closure lids individually from the stacking device to the at least one receiving area of the transfer apparatus.

The invention also relates to a method for conveying closure lids, in particular for cans, wherein the lowermost closure lids in the stacking device in each case are transferred from a stacking device containing a stack of closure lids to an apparatus for further processing by means of a transfer apparatus with at least one receiving area for a closure lid, wherein the closure lids are supplied individually from the stacking device to the at least one receiving area of the transfer apparatus by means of at least one conveyor worm driven in a drive direction.

Devices for manufacturing cans can be designed in the form of so-called rotary liners. They generally comprise a stacking device in which a stack of closure lids is received such that same are stacked directly one on top of the other. A transfer apparatus which comprises, for example, a rotationally driven transfer disk with receiving areas on the periphery thereof for one closure lid in each case, a so-called star wheel, receives closure lids from the stacking device and conveys them to an apparatus for further processing, which may in turn comprise a rotary table, for example, to which rotary table the closure lids are transferred individually from the receiving areas of the transfer disk for further processing, for example for connection to a can body or for shaping the closure lids, etc.

Typically, the lowermost closure lids in the stacking device are supplied individually from the stacking device to the receiving areas of the transfer disk by a worm drive with one or more conveyor worms. In the prior art, the drives of the conveyor worm apparatus, the transfer apparatus, and one or more apparatuses for further processing are generally mechanically coupled to one another. This provides particularly reliable synchronization of the different components with one another. However, in the event of a fault, for example in the stacking device, triggered for example by an incorrectly aligned closure lid in the stacking device, or a fault downstream of the stacking device, this leads to the problem that closure lids continue to be supplied from the stacking device to the transfer apparatus and thus to the apparatus for further processing, even though this should no longer happen due to the fault.

DE 28 411 45 C2 discloses a device for interrupting the supply during discharge of can closure lids from a stacking device, wherein interruption members can be swung into the stacking device above the conveyor worms so that the supply of further closure lids from the stacking device is interrupted. Accordingly, no further closure lids are supplied to the conveyor worms and thus to the subsequent components of the device either. In this way, an undesired further supply of closure lids can be prevented, for example in the event of a defect downstream of the stacking device. However, the adjustment of the interruption members designed as separating blades is extremely difficult. This is in particular due to the fact that access to the stacking device in such devices is generally greatly restricted. Incorrect adjustment of the interruption members can lead to damage to the closure lids and thus to impairment of production. This applies both to the vertical position of the separating blades and to the timing. Height tolerances when rolling on the outer edges of the lids, which influence the stack division, also play a role.

A further problem is that of synchronizing the conveyor worms with subsequent components, in particular a transfer disk. As explained, the mechanical coupling of the drives to one another provided in the prior art ensures that the synchronization can be reliably maintained after it has been correctly set. However, the initial setting of the synchronization in the course of the mechanical adjustment is very laborious and often has to take place empirically within the scope of a lengthy trial and error method. Proceeding from the explained prior art, the object of the invention is to provide a device and a method of the type mentioned at the outset with which it is possible to interrupt the supply of closure lids and with which synchronization is simplified in a simple and safe manner.

The invention achieves the object through the independent claims 1 and 9. Advantageous embodiments can be found in the dependent claims, the description, and the figures.

With regard to a device of the type mentioned at the outset, the invention achieves the object in that the at least one conveyor worm can be driven and stopped by means of the worm drive independently of the transfer apparatus, and in that a control apparatus is provided which is designed to actuate the worm drive after the at least one conveyor worm has been stopped in order to drive the at least one conveyor worm counter to the drive direction before being started up again.

With regard to a method of the type mentioned at the outset, the invention achieves the object in that the at least one conveyor worm is driven and stopped independently of the transfer apparatus, and in that the at least one conveyor worm is driven counter to the drive direction after being stopped and before being started up again.

In the present case, the term “closure lid” is used in a general manner and may form both an upper as well as a lower lid of a container, for example a can. Thus it may also be a base of a can, for example. The closure lid may also be part of a packaging or the like. In principle, the closure lid may consist, for example, of metal, in particular sheet metal. The closure lids may have a circular shape, for example. However, shapes that deviate from a circular shape, in particular non-circular closure lids, are also possible.

As explained at the outset, the closure lids lie in the stacking device generally so as to be stacked directly one on top of the other. The lowermost closure lids of the stacking device in each case are received by the transfer apparatus in the at least one receiving area thereof and conveyed by said transfer apparatus for further processing in the apparatus for further processing. The apparatus for further processing may, in principle, be any desired apparatus for further processing for the closure lids. It may, for example, be an apparatus for shaping the closure lids or for connecting the closure lids to further components, for example a base body of a can or a packaging. The apparatus for further processing may, in particular, be a so-called rotary liner. However, it may also be a transfer press for producing ring pull lids or a packaging machine, for example.

A conveyor worm apparatus with at least one conveyor worm is provided for separating and conveying the lowermost closure lids in each case from the stacking device to the transfer apparatus. The conveyor worm is driven by means of a worm drive in a drive direction, in particular rotationally in a first direction of rotation. The conveyor worm receives, in the flight thereof, the lowermost closure lids in each case from the stacking device, separates said closure lids as a result, and supplies them to the receiving area of the transfer apparatus. A control apparatus is provided for actuating the worm drive.

According to the invention, it is initially provided that the at least one conveyor worm can be driven and stopped by means of the worm drive independently of the transfer apparatus. It is also possible that the at least one conveyor worm can be driven and stopped by means of the worm drive also independently of the apparatus for further processing or further components of the device for processing the closure lids. When the at least one conveyor worm is stopped, the transfer apparatus and/or the apparatus for further processing may thus continue to run. The possibility of stopping the at least one conveyor worm independently of the transfer apparatus and, if applicable, the apparatus for further processing allows for a very rapid interruption in the supply of closure lids, for example in the event of faulty conveying or faulty alignment of a closure lid or another fault downstream of the stacking device. According to the invention, the worm drive is not coupled to drives of the transfer apparatus and, if applicable, of the apparatus for further processing. Thus an interruption to the further supply of closure lids via the at least one conveyor worm to the transfer apparatus is possible in a simple manner. The interruption members provided in the prior art, designed as separating blades, and pivotable into the stacking device are thus not required, and therefore the above-explained problems associated with them are avoided. In addition, in the prior art, the separating blades are arranged above the worm(s) and thus it is often not possible to prevent some further lids from being supplied, with the associated consequences, in spite of the intended interruption. These problems are also prevented according to the invention.

After the at least one conveyor worm has been stopped and while the transfer apparatus continues to run in the meantime, the at least one conveyor worm must be strongly accelerated within a short time when it is started up again in order to supply the closure lids, conveyed by means of the at least one conveyor worm, to the at least one receiving area of the continuing transfer apparatus in a reliably synchronized manner. In particular in the case of fast-running transfer apparatuses which convey more than 1,000 closure lids per minute, for example, this is not always reliably possible over a potentially only short start-up distance of the at least one conveyor worm. Therefore, it is further provided according to the invention that the at least one conveyor worm is driven counter to the drive direction, i.e. in particular counter to the first direction of rotation, by means of the worm drive after being stopped and before being started up again. The at least one conveyor worm will thus travel back by a particular travel distance after being stopped and before being started up again. In this way, the available start-up distance is maximized when the at least one conveyor worm is started up again, so that the at least one conveyor worm can be accelerated sufficiently strongly over this available, extended start-up distance, so that, even in the case of a fast-running transfer apparatus, safe synchronization of the at least one conveyor worm with the transfer apparatus and thus safe synchronized transfer of the closure lids into the at least one receiving area of the transfer apparatus is reliably possible in a simpler manner and until an automated synchronization. The at least one conveyor worm may be retracted so far, for example, that a closure lid already held by means of the at least one conveyor worm, in particular a lowermost closure lid already held by means of the conveyor worm, is moved back to the stack of closure lids in the stacking device. On account of this extension of the start-up distance for the at least one conveyor worm, the worm drive is reliably and safely synchronized with the process running at conveyor speed from a standstill within one supply cycle even in the case of very fast-running transfer apparatuses.

As already mentioned, an automated synchronization is possible here. For this purpose, the arrival of a closure lid in the at least one receiving area can be detected by means of at least one sensor. Based on the measurement results of the at least one sensor, the starting point of the retracted conveyor worm can be set and optimized according to the dynamics of the drive.

It should also be mentioned that the retraction of the conveyor worm is associated with an upward pushing of the closure lids counter to the force of gravity. In order to limit the weight of the lid stack on the conveyor worm, a so-called lid brake can be used. A lid brake of this kind creates a clearance of up to one half of a lid diameter approx. 5 to 10 cm above the conveyor worm. This clearance is then available for pushing the closure lids upward and a limiter prevents the closure lids from flipping over.

According to one embodiment, the transfer apparatus may comprise a transfer disk which is rotationally driven by means of a transfer drive and on the periphery of which multiple receiving areas for one closure lid in each case are arranged. The transfer drive may thus be a rotary drive, in particular. The transfer drive may be coupled, in particular mechanically coupled, to the drive of the apparatus for further processing. The above-mentioned embodiment of the transfer apparatus with a transfer disk with multiple receiving areas for one closure lid in each case and arranged in the manner of a star on the periphery is particularly well suited for transferring the closure lids to rotary liners, for example.

The transfer drive may further be designed to rotationally drive the transfer disks at a rotational speed so that the transfer disk transfers more than 1,000 closure lids per minute, in particular more than 1,500 closure lids per minute, for example up to 1,800 closure lids per minute, from the stacking device to the apparatus for further processing. The at least one conveyor worm must convey the closure lids in an accordingly fast and synchronized manner into the receiving areas of the rapidly rotating transfer disk. As explained, the renewed start-up after a stop and the synchronization required again with this is problematic, in particular at such high speeds, but is reliably possible according to the invention. Rotary liners, in particular, are generally operated at such high speeds.

According to a further embodiment, the conveyor worm apparatus may comprise at least two conveyor worms that are driven by means of the worm drive and that are arranged on different sides, in particular opposite sides, of the stacking device and that receive between their flights the closure lids to be supplied individually from the stacking device to the at least one receiving area of the transfer apparatus. This ensures that the closure lids are received and thus conveyed into the receiving areas of the transfer apparatus in a particularly safe manner. Of course, the conveyor worm apparatus could also comprise more than two conveyor worms. The worm drive may comprise, for example, separate drive means for the two or more conveyor worms, for example separate electric motors, or common drive means, for example a common electric motor, for multiple conveyor worms.

The flights of the conveyor worms may further be designed in each case to hold multiple closure lids individually at the same time. Therefore, multiple closure lids are held between the conveyor worms at the same time separately, i.e. separated from one another, and supplied one after the other to the receiving area of the transfer apparatus. Thus, the flight of the conveyor worms is extended in practice, so that said conveyor worms can receive multiple closure lids at the same time, but such that they are separated. As a result, the start-up distance is further extended in the event of a stop and subsequent retraction of the conveyor worms, so that there is a greater start-up distance after a stop for the required synchronization with the transfer apparatus and, if applicable, the apparatus for further processing, which continue to run.

As already explained, the worm drive may comprise at least one electric motor. In a particularly practical manner, the worm drive may comprise at least one servo drive. As already explained, it is possible that a dedicated electric motor or else a dedicated servo drive is provided for each of the potentially multiple conveyor worms provided, or that a common electric motor or else servo motor is provided for multiple conveyor worms. The above-mentioned drive means are particularly suitable for independent driving and for simple and fast synchronization. Servo drives, in particular, can be controlled in a fast and precise manner by means of the control apparatus, and therefore the synchronization is further simplified.

The device may also comprise the apparatus for further processing. The method according to the invention can be carried out with a device according to the invention. Accordingly, the device according to the invention can be designed to carry out the method according to the invention.

An exemplary embodiment of the invention is explained in greater detail below based on a FIGURE. The single FIGURE schematically shows a device according to the invention in a partially sectional view.

The device shown in the FIGURE is used to convey closure lids for cans. It comprises a stacking device 10 for receiving a stack 12 of closure lids 36. For this purpose, the stacking device 10 comprises a cylindrical housing 14 with an upper opening 16 via which closure lids 36 are supplied to the inside of the housing 14, for example from a supply apparatus arranged upstream of the stacking device 10, in order to form a stack 12. A mounting flange 18 is provided in the region of the upper opening 16 of the housing 14 for connection to a supply apparatus of this kind. On its underside, the housing 14 also comprises a mounting flange 20, via which the housing 14 is connected to a housing 22 of a conveyor worm apparatus. In the example shown, the conveyor worm apparatus comprises two conveyor worms 24, 26 arranged on opposite sides of the stacking device 10. The conveyor worms 24, 26 are in each case rotationally driven by means of a servo drive 32, 34 that is connected to the conveyor worms 24, 26 via a drive shaft 28, 30. The servo drives 32, 34, which each comprise an electric motor, and the drive shafts 28, 30 are located inside the housing 22 and the conveyor worms 24, 26 are located on the underside of the housing 22.

As can be seen in the FIGURE, in the course of their rotation, the conveyor worms 24, 26 receive in their flights the lowermost closure lids 36 in each case from the stack 12 inside the stacking device 10 and, in this way, convey said closure lids 36 individually downward out of the stacking device 10. In the example shown in the FIGURE, the flights of the conveyor worms 24, 26 are each designed to receive three closure lids 36 individually at the same time and to convey them downward. The flights may thus also be progressive and thus increase the spacing between the lids during the conveying.

A transfer disk 40 of a transfer apparatus is located below the stacking device 10 and is rotationally driven by means of a transfer drive 38, in the present case a rotary drive 38. The transfer disk 40 comprises, on its periphery, multiple receiving areas 42 for one closure lid 36 in each case. The transfer disk 40 is aligned with the stacking device 10 in such a way that the receiving areas 42 rotate through below the closure lids 36 separated by the conveyor worms 24, 26 and in each case receive one of the closure lids 36 with corresponding synchronization. A control apparatus 44 of the device actuates at least the servo drives 32, 34 and thus the conveyor worms 24, 26, wherein the servo drives 32, 34, and with them the conveyor worms 24, 26, can be driven and stopped independently of the transfer drive 38. The closure lids 36 received in the receiving areas 42 of the transfer disk 40 are further conveyed by means of the transfer disks 40 to an apparatus for further processing (not shown), where the closure lids 36 are processed further, for example connected to cylindrical base bodies of cans. For this purpose, the apparatus for further processing may comprise a rotary table which, in turn, receives the closure lids 36 received in the receiving areas 42, as is known per se. The transfer drive 38 may, for example, be mechanically coupled to a drive of the apparatus for further processing.

Due to the fact that the servo drives 32, 34 and thus the conveyor worms 24, 26 can be stopped by means of the control apparatus 44 independently of the transfer drive 38 and, if applicable, a drive of the further processing apparatus, a supply of further closure lids 36 to the transfer disk 40 can, if necessary, be interrupted quickly and reliably, for example in the event of a production error downstream. After a stop, in order to be able to synchronize the conveyor worms 24, 26 with the transfer disk 40 again, which continues to rotate, for example, and thus to reliably ensure that the closure lids 36 are transferred into the receiving areas 42, after a stop the control apparatus 44 actuates the servo drives 32, 34 in a direction of rotation counter to the drive direction for conveying the closure lids 36 downward, so that the closure lids 36 held in the flights of the conveyor worms 24, 26 are retracted upward again in the direction of the stack 12, for example up to the stack 12. In this way, for a renewed start-up of the conveyor worms 24, 26, the acceleration distance required for synchronization with the rapidly rotating transfer disk 40 is maximized so that renewed synchronization is safely ensured after the stop. By extending the flights of the conveyor worms 24, 26 such that they can receive multiple closure lids 36 individually at the same time, the available start-up distance can be further maximized.

As explained at the outset, it is possible, for example, that the transfer disk 40 is rotationally driven by means of the transfer apparatus 38 at such a rotational speed that the transfer disk 40 conveys more than 1,000 closure lids per minute, in particular more than 1,500 closure lids per minute. In the case of such high rotational speeds, in particular, reliable synchronization of the conveyor worms 24, 26 during start-up within one transfer cycle is a challenge that can be safely overcome according to the invention.

### LIST OF REFERENCE SIGNS

10 Stacking device
12 Stack
14 Housing
16 Opening
18 Mounting flange
20 Mounting flange
22 Housing
24 Conveyor worm
26 Conveyor worm
28 Drive shaft
30 Drive shaft
32 Servo drive
34 Servo drive
36 Closure lid
38 Transfer drive
40 Transfer disk
42 Receiving areas
44 Control apparatus

1. A device for conveying closure lids, in particular for cans, comprising a stacking device (10) for receiving a stack (12) of closure lids (36), additionally comprising a transfer apparatus for transferring the lowermost closure lids (36) in the stacking device (10) in each case to an apparatus for further processing, wherein the transfer apparatus has at least one receiving area (42) for a closure lid (36), and comprising a conveyor worm apparatus with at least one conveyor worm (24, 26) and a worm drive, by means of which the at least one conveyor worm (24, 26) can be driven in a drive direction so that the at least one conveyor worm (24, 26) supplies the closure lids (36) individually from the stacking device (10) to the at least one receiving area (42) of the transfer apparatus, characterized in that the at least one conveyor worm (24, 26) can be driven and stopped by means of the worm drive independently of the transfer apparatus, and in that a control apparatus (44) is provided which is designed to actuate the worm drive after the at least one conveyor worm (24, 26) has been stopped in order to drive the at least one conveyor worm (24, 26) counter to the drive direction before being started up again.

2. The device according to claim 1, characterized in that the transfer apparatus comprises a transfer disk (40) which is rotationally driven by means of a transfer drive (38) and on the periphery of which multiple receiving areas (42) for one closure lid (36) in each case are arranged.

3. The device according to claim 2, characterized in that the transfer drive (38) is designed to rotationally drive the transfer disk (40) at a rotational speed so that the transfer disk (40) transfers more than 1,000 closure lids (36) per minute, in particular more than 1,500 closure lids (36) per minute, from the stacking device (10) to the apparatus for further processing.

4. The device according to one of the preceding claims, characterized in that the conveyor worm apparatus comprises at least two conveyor worms (24, 26) that are driven by means of the worm drive and that are arranged on different sides, in particular opposite sides, of the stacking device (10) and that receive between their flights the closure lids (36) to be supplied individually from the stacking device (10) to the at least one receiving area (42) of the transfer apparatus.

5. The device according to claim 4, characterized in that the flights of the conveyor worms (24, 26) are further designed in each case to hold multiple closure lids (36) individually at the same time.

6. The device according to one of the preceding claims, characterized in that the worm drive comprises at least one electric motor.

7. The device according to one of the preceding claims, characterized in that the worm drive comprises at least one servo drive (32, 34).

8. The device according to one of the preceding claims, characterized in that it further comprises the apparatus for further processing.

9. A method for conveying closure lids, in particular for cans, wherein the lowermost closure lids (36) in the stacking device (10) in each case are transferred from a stacking device (10) containing a stack (12) of closure lids (36) to an apparatus for further processing by means of a transfer apparatus with at least one receiving area (42) for a closure lid (36), wherein the closure lids (36) are supplied individually from the stacking device (10) to the at least one receiving area (42) of the transfer apparatus by means of at least one conveyor worm (24, 26) driven in a drive direction, characterized in that the at least one conveyor worm (24, 26) is driven and stopped independently of the transfer apparatus, and in that the at least one conveyor worm (24, 26) is driven counter to the drive direction after being stopped and before being started up again.

10. The method according to claim 9, characterized in that the lowermost closure lids (36) in the stacking device (10) in each case are transferred to the apparatus for further processing by means of a rotationally driven transfer disk (40) with multiple receiving areas (42) on its periphery for one closure lid (36) in each case.

11. The method according to claim 10, characterized in that the transfer disk (40) is rotationally driven at a rotational speed so that the transfer disk (40) transfers more than 1,000 closure lids (36) per minute, in particular more than 1,500 closure lids (36) per minute, from the stacking device (10) to the apparatus for further processing.

12. The method according to one of claims 9 to 11, characterized in that the closure lids (36) held between the flights of at least two conveyor worms (24, 26) arranged on different sides, in particular opposite sides, of the stacking device (10) are supplied individually from the stacking device (10) to the at least one receiving area (42) of the transfer apparatus.

13. The method according to claim 12, characterized in that the flights of the conveyor worms (24, 26) hold multiple closure lids (36) individually at the same time.

14. The method according to one of claims 9 to 13, characterized in that the at least one conveyor worm (24, 26) is driven by means of at least one electric motor.

15. The method according to one of claims 9 to 14, characterized in that the at least one conveyor worm (24, 26) is driven by means of at least one servo drive (32, 34).

16. The method according to one of claims 9 to 15, characterized in that it is carried out with a device according to one of claims 1 to 8.
